(19) United States
(12) Patent Application Publication
(10) Pub. No.: US 2014/0077727 A1
(43) Pub. Date: Mar. 20, 2014

(54) INTEGRATED ELECTRIC FIELD PROCESSOR EMITTER MATRIX & ELECTRIC FIELD PROCESSOR EMITTERS & MOBILE EMITTERS FOR USE IN A FIELD MATRIX

(71) Applicant: Robert Dennis Kennedy, Honolulu, HI (US)

(72) Inventor: Robert Dennis Kennedy, Honolulu, HI (US)

(21) Appl. No.: 13/622,424

(22) Filed: Sep. 19, 2012

(51) Int. Cl. H01J 1/304

(52) U.S. Cl. 315/326

(57) ABSTRACT

A plurality of field emitting conductors placed in various matrix, mesh, grid, lattice patterns, and on board pluralities of autonomous vehicular like on wire or unteathered free ranging micro-robots wherein the field emitters are charged and modulated with a plurality of timing algorithms and electric circuitry which produce a three dimensional electric field shape or a plurality of shapes or plurality of duplicate electric field shapes which are animated or moved through space in a sequence, in unison or in wavelike patterns or evolved to different shapes or quickly changed to a new shape. The field emitter voltage can be raised or lowered to depict, render or facilitate motion in a direction or its opposite charge direction. An alternating current can produce a shape that modulates to a zero voltage cross point for example and then outward or inside out (expansion and contraction with inversion and inverse expansion and contraction). With the added integration of logic and loop capable software at each field emission location such as vertices of a matrix, lattice, grid, mesh or mobile emitters on board a micro-robot wherein each has its own processing capability and can navigate, maneuver and move through the space where the matrix generated fields exist and obtain energy from and communicate to the matrix of field emitters, a universe or arena of emitters can be controlled in parallel.

### FIELD OF THE INVENTION

This invention relates to the creation and control of electric fields en mass to create, shape or affect other fields by producing field movement or field shapes or field presence within another independently controlled electric field or to produce an electric field, pluralities of electric fields or a larger electric field of a particular shape or intensity or warp configuration or with a particular motion or with the properties to move another field, move a charge or move, orient, propel or change the trajectory of relatively free floating dipole, non-dipole, or autonomous vehicular objects that generate and control a singular field, control polarity or a plurality of their own electric fields to maneuver and navigate a matrix of pluralities of fields in an environment which may be or consist of liquid, gas, plasma or solids to do work or produce additional field shapes or topology.

### BACKGROUND OF THE INVENTION

In recent years parallel processing, multi-core processors and parallelism in graphics processors have continued pushing the envelope in computing operations done per second. Methods of computational field dynamics have required large render times with prior-art. Many simplified processors in parallel rather than a few fast centralized processors may enable the state of the art to advance.

In view of these advantages to do field dynamics operations in real-time this invention embraces parallel computing through the use of a matrix or other structure which responds to op-code like commands concurrently with logic and or at least one instance of loop capable execution and is populated by a plurality or pluralities of electric field processor emitters wherein each electric field processor emitter has logic and or at least one instance of loop capable execution wherein the matrix control can issue an op code like command over the matrix to all the electric field processor emitters which includes autonomous navigators or Bead-like Energetic Autonomous Navigators (B.E.A.N.s) wherein an instance of execution or logic in the electric field processor emitter and Bead-like Energetic Autonomous Navigator respond concurrently to render, move or change electric fields or to influence other independently controlled fields or to give B.E.A.N.s work commands in real-time.

Similar to computational field dynamics simulation using grid points to visualize experiments with various parameter changes to affect characteristics or a parameter say field gradient electric field force the characteristics and or parameters affecting an electric field are altered in a similar manner using an actual device that generates and controls an electric field which in turn populate in plurality a grid like or matrix like structure to create, control or change: its own created electric field/s, an independent electric field/s, an electro-magnetic field/s, an object, the properties near or on the surface of or surrounding an object, a process, or to command and power pluralities of free ranging, wireless, vehicular micro-robots called B.E.A.N.s (Bead-like Energetic Autonomous Navigators) which also are electric field processor emitters and include Integrated Electric Field Processor Emitters (I.E.F.P.E.).

A key difference from a computational field dynamics simulation is that real fields are used and in real-time. Combined with B.E.A.N.s which have I.E.F.P.E./s on-board. A variety of objects can be added with various characteristics into the arena containing both a matrix of I.E.F.P.E.s and free ranging I.E.F.P.E.s in the form of B.E.A.N.s. Parallelism is achieved since each electric field processor emitter is a processor capable of responding to commands issued in parallel so the entire matrix responds in unison and with synchronization. One is now free from the latency required to do similar work required for rendering a field dynamics or field simulation or visualization.

In view of these advantages it is the object of this invention to use a matrix or other structure which responds to op code like commands with logic or at least one instance of loop capable execution and is populated by a plurality or pluralities of Integrated Electric Field Processor Emitters wherein each I.E.F.P.E. has logic or at least one instance of loop capable execution wherein the matrix control is capable of issuing an op code like command over the matrix to all the I.E.F.P.E. wherein each I.E.F.P.E. may respond concurrently to render, move or change electric fields or to influence other independently controlled fields in real-time.

### SUMMARY OF THE INVENTION

Pluralities of processors, capacitors, small-transformers, transistors, resistors, diodes, conductors, and electromechanical micro machinery are integrated together or fabricated as an integrated device for controlling and producing or emitting an electric field. The Integrated Electric Field Processor Emitter requires only a low 2.4 volts or less to become energized and emit a non-trivial electric field.

This Integrated Electric Field Processor Emitter placed on board a Bead-like object which can float freely or be threaded on a wire and obtains its energy from a Rf, piezoelectric material, light, or a field can be used to control orientation, polarity, charge, trajectory, or propulsion.

Placed in a matrix, lattice or on-board a free ranging autonomous vehicular like object these Electric Field Processor Emitters form a parallel processing system which can generate synchronized waves of electric fields or sequences of electric field activations.

Individual Integrated Electric Field Processor Emitters can be produced with prior art semiconductor manufacturing techniques to reduce cost. Integrating the conductors, capacitor, diodes, resistors and transformer, and other circuitry together in a tight space allows low voltage to be used to power the individual emitter preventing metal interconnects and other circuitry from creating unwanted additional field effects or antenna like effects on the field.

The capacitor structure such as metalized films or other capacitive dielectric material (Ta2O5 or Niobium Oxide for example) and other needed circuitry and metalized/metal/conductor structures may lay below a planar BSG, BPSG structure which has metal conductor edge exposures necessary to emit the electric field in a space above plane or at a point in a lattice which remains clear of other objects or structures allowing one to place an object or flow of particles, liquids, solids or gases through a lattice or other confined space or orifice with a field generating device in this area to be manipulated or controlled.

The substrata or material wherein the Integrated Electric Field Processor Emitter is situated is not limited to silicon but may also be another translucent material, plastic or other material wherein for example a clear screen-protector like device encapsulating an I.E.F.P.E. matrix can be placed over the front of a tablet computer or mobile phone to trigger a touch screen. It is also possible to embed the I.E.F.P.E. within a material or within a device or structure/s to provide field control or generation within the material or within a device/s.

Micro mechanical motion employed at the emitter locations in a matrix or on-board the moveable or autonomous object can be used to move the conductor/s into or out of an electrostatic condition or change polarity or re-orient the polarity or change asymmetry in the conductor by employing flippers or filament conductor movements or conductor movements to cause field emission to be stronger on one side than the other to orient or turn. Each emitter location has a logic or a register transfer language like command processor or op code micro processor that responds in real-time. The micro electro mechanical motion can also be used to propel an on wire Bead-like Energetic Autonomous Navigator to another position on a wire or to propel a wireless B.E.A.N.

The matrix or other structure responds to op code like commands wherein the matrix control can issue an opcode like command over the matrix to all the I.E.F.P.E and each I.E.F.P.E. may respond concurrently to render, move or change electric fields in real-time. A subset of matrix commands are listed below that are issued to a matrix which in turn commands electric field processor emitters with parallelism:

### Activate Field

{x,y . . . xn,yn} {time quantum}

### Translate all

Possible parameters
{charge properties} {grain}left
{charge properties} {grain}right
{charge properties} {grain} up
{charge properties} {grain} down
{charge properties} {grain} upleft
{charge properties} {grain} {charge properties} upright
{charge properties} {grain} downleft
{charge properties} {grain} downright

### Translate

{charge properties} {x,y . . . xn,yn} {grain} left
{charge properties} {x,y . . . xn,yn} {grain}right
{charge properties} {x,y . . . xn,yn} {grain}up
{charge properties} {x,y . . . xn,yn} {grain} down
{charge properties} {x,y . . . xn,yn} {grain} upleft
{charge properties} {x,y . . . xn,yn} {grain} upright
{charge properties} {x,y . . . xn,yn} {grain} downleft
{charge properties} {x,y . . . xn,yn} {grain} downright

### Radius Change

dialate from x,y
constrict from x,y

### Charge Properties

steady−voltage value, time quantum
steady+voltage value, time quantum
−limit voltage, +limit voltage zero cross, time quantum −, time quantum + step voltage, no of steps, step quantum time and voltage peak +,peak −

### Granularity Options

1-100000
move left grain x
move right grain x
move in from x, y −40
increase radius point x,y 1 to 30
   Other more complex commands are issued for B.E.A.N. operation which are issued in parallel to these autonomous ranging vehicles such as return home, go to this position at propel speed x, dispense, emit in a specified direction, intensity u, yaw, pitch, attach, and hover.

### BRIEF DESCRIPTION OF THE DRAWINGS

FIG. 1 is a perspective view of an Integrated Electric Field Processor Emitter

FIG. 2 shows a lattice of three conductor body combinations or wire groupings for each field emitter that can be sandwiched or encapsulated in a clear plastic to overlay a screen or embedded in another solid or in a liquid material and used to place near something to convey electric fields or switch on precisely located electric fields with specific intensities and groupings and timings for many purposes such as simulating finger touches to a touch screen or to transmit data or to create a undulating or wavelike movement of fields to aid in propulsion and energize a miniature autonomous navigator

FIG. 3 is a flow diagram of the procedure for the parallel command of an electric field processor emitter

FIG. 4 illustrates groupings of three conductor bodies for each input bit in a parallel bus lattice of eleven bits with one clock bit

FIG. 5 illustrates the field activation rough field flux lines to approximate a vertical finger swipe for use with a mobile phone touch screen wherein each individual field is activated in a sequence

FIG. 6 illustrates the field activation rough field flux lines to approximate a diagonal finger swipe for use with a mobile phone touch screen wherein each individual field is activated in a sequence

FIG. 7 illustrates the field activation rough field flux lines to approximate a finger pinch sequence wherein two fields one on each side are activated in a sequence

FIG. 8 illustrates a mobile phone or tablet computer inside a snap on clear plastic case with an embodiment of this invention which facilitates the use of the phone as a probe device

FIG. 9 illustrates a mobile phone or tablet placed on its side and held in place by a partial case-like fixture or snap in slot holder with an embodiment of this invention

FIG. 10 illustrates a Bead-like Energetic Autonomous Navigator

FIG. 11 illustrates a group of Bead-like Energetic Autonomous Navigators on a wire over a matrix field emitter; and

### DETAILED DESCRIPTION

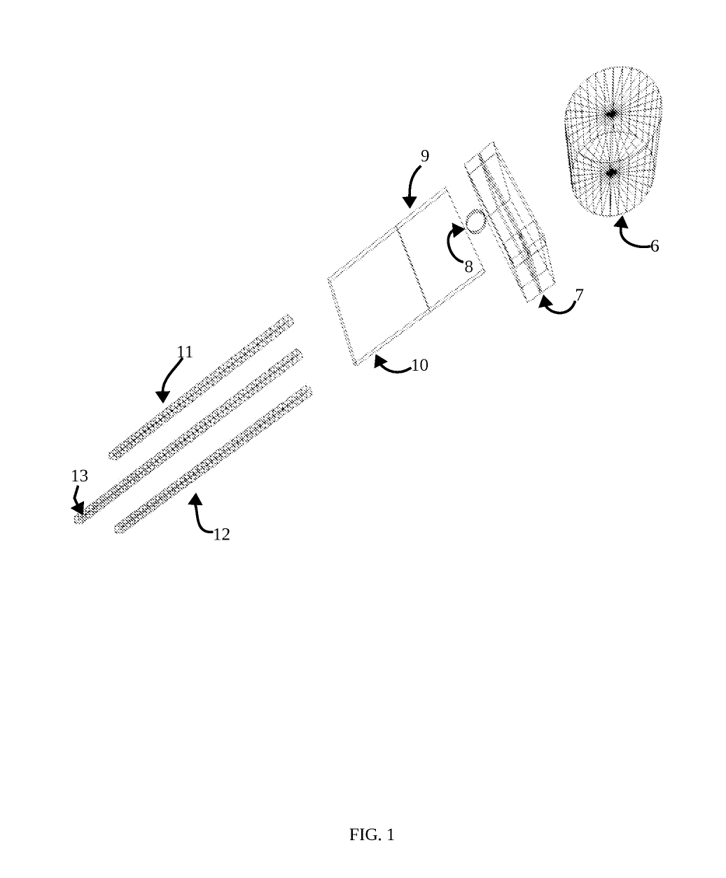

FIGS. 1 through 11 detail electric field processor emitter device matrices with parallel control and integrated emitter processor devices with conjugate autonomous navigator element emitter processor devices which can traverse the field matrix according to this invention. While this embodiment details functionality relating to tablet computers and mobile phones allowing them to be instrumented embedded sensor platforms or to be used in multi-computing systems these devices, matrices and systems herein can be adapted to a wide variety of other applications wherein these systems or devices or matrices can be built into an application specific product or attached to an existing tablet or mobile phone such as a medical device for analyzing tissue externally or from a distance or a device used for measuring the topology of an object or a multi-purpose probe device or a device specifically for changing the characteristics of a flowing or not flowing ingredient of a process such as a gas, particles, or liquids. These can pass through a lattice of electric field processor emitters wherein properties can be altered to control a process such as layered positive and negatively charged material or varying density of charged deposited material due to the fact that the electric field can be precisely controlled and reversed in charge. Used in the manufacture of VLSI circuits, micro machines, capacitive dielectrics, metalized layers, metal conductors, as a form of electronic pattern transfer function during or between semiconductor etch or deposition steps of manufacture or display screen or touch screen manufacture. It may also be used to electronically find high spots on wafers or to find specific locations on a wafer or do test functions. Placed behind above or near a wafer or other material substrate to produce a field useful for controlled asymmetric or patterned deposition or etch or used to line the walls of a chamber to prevent deposition of materials where deposition is unwanted to reduce the use of dangerous cleaning agents.

Numerous medical applications exist. Internal suturing or clotting methods can be produced to allow the physician to administer B.E.A.N.s intravenously for example. These then can travel throughout the body which can be bathed in an electric I.E.F.P.E. matrix or lattice of fields facilitating the free travel of B.E.A.N.s throughout the body to use appropriate onboard sensing to find a certain physical feature or other to go to work clotting, removing, boring carrying waste material from a work site out of the body. The patient may have to lay on a surface which may have millions of I.E.F.P.E.s to energize and control the B.E.A.N.s or a portable kit may be in the cast-like form or head-gear used to allow a continuous use of B.E.A.N.s on a patient who may require longer periods of treatment or permanent treatment. Delivery of medicines wherein a specific site of the body can be marked with the electric field matrix so that a specific area can be targeted or B.E.A.N.s can seek out appropriate sites to administer treatment. Numerous other forms of work can be done.

A 3-D display system utilizing a plurality particles which can be manipulated in space by the electric field shape and modulation control by a plurality of transmission points or a massive plurality of pluralities of field transmission end points or conductor edges among a plurality of conductors.

Pluralities of electric field emitters may be divided into networks or pluralities of grids or matrices within matrices or grids within grids or some asymmetric plurality. Each of these groupings may have a matrix controller that issues commands to a plurality of electric field processor emitters.

FIG. 1 details the structures each field emitter requires including a small transformer 6, a relatively high voltage metalized film/polyester/Ta2O5 or Niobium Oxide capacitor 7, a photoresistor or pair of photoresistors 8, diodes and resistors and transistors 9, three field generating conductor lengths or bodies 11, 12, and 13 that produce electric fields and electric fringe fields and if integrated small geometry/sub-micron processor/s 10 or logic to execute op codes or commands and if integrated a looping software capability. Integrated together this forms an Integrated Electric Field Processor Emitter.

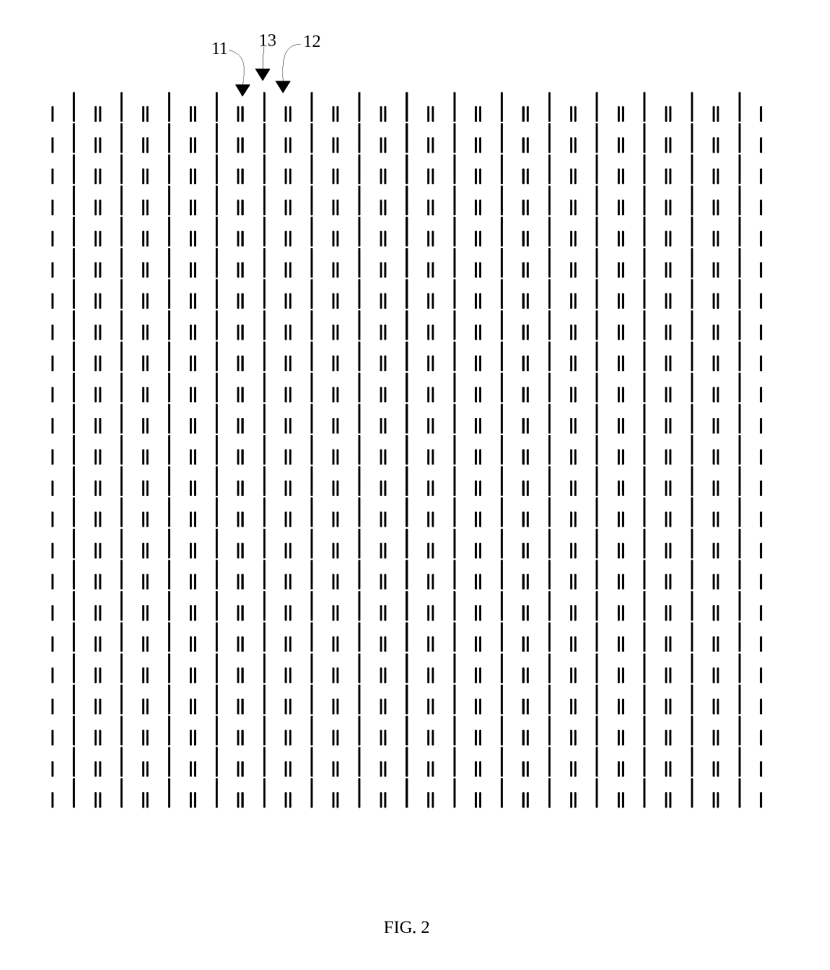

FIG. 2 details a 23×15 lattice of 345 combinations of the three field generating conductor lengths or bodies consisting of two shorter conductor lengths 11 and 12 and a middle longer conductor length 13.

A mesh, asymmetric mesh, matrix, lattice, or grid of devices wherein each device is comprised of processing logic co-located with electric potential generating circuitry structures; capacitors, diodes, resistors, transistors, micro-transformers, micro coils, and as needed micro electro mechanical machines. Each device in the matrix structure respond to commands in unison/parallel. Each device in the matrix is an Integrated Electric Field Processor Emitter.

The integrated nature of these field processor emitters can be realized on a large scale or a small 900 micron or smaller scale using prior art semiconductor manufacturing techniques. I.E.F.P.E. (Integrated Electric Field Processor Emitters) avoid antenna effect like problems and allows low supply voltage while allowing an electric potential (or higher voltages) to be produced locally. In combination with micro machine structures a persistent electric potential may exist while moving a conductor out of symmetry or to a different position (via micro machine force multiplier moving structures for example) to vary the devices generated electrostatic condition from peak field emission to field emission off. This can be used to produce a modulation and or change in voltage. A modulation may also be produced by turning supply voltage on and off or creating an alternating current like condition in the charge circuit.

A cascade of modulations or pluralities of I.E.F.PE.s in the matrix can be used to produce a wave like electric field structure or other type of motion or sequence of movements. Because each emitter is controlled by a processor, all emitter response is concurrent allowing the entire matrix to respond. Massive parallelism is achieve by high speed transistor transistor logic within each emitter.

Larger devices may be used as well if small scale devices are not needed or are not economical. These devices can be manufactured and packaged using prior art semiconductor manufacturing techniques and can be done on a wafer scale 200 mm, 300 mm and larger. 300 mm wafers can be cut and butt up with one another to form very large matrix structures.

Similar to the computational field dynamics simulations using grid points to visualize experiments with various parameter changes to affect characteristics or a parameter say velocity or field gradient electric field force or boundary forces, the characteristics and or parameters affecting an electric field can be altered or experimented with using this matrix of IEFPEs as well but with the key difference being that it is done with a real field, and in real-time. Responses of the matrix behave in real-time unlike prior art computational field dynamics software used for visualization requiring a rendering latency and super-computing capabilities in prior-art.

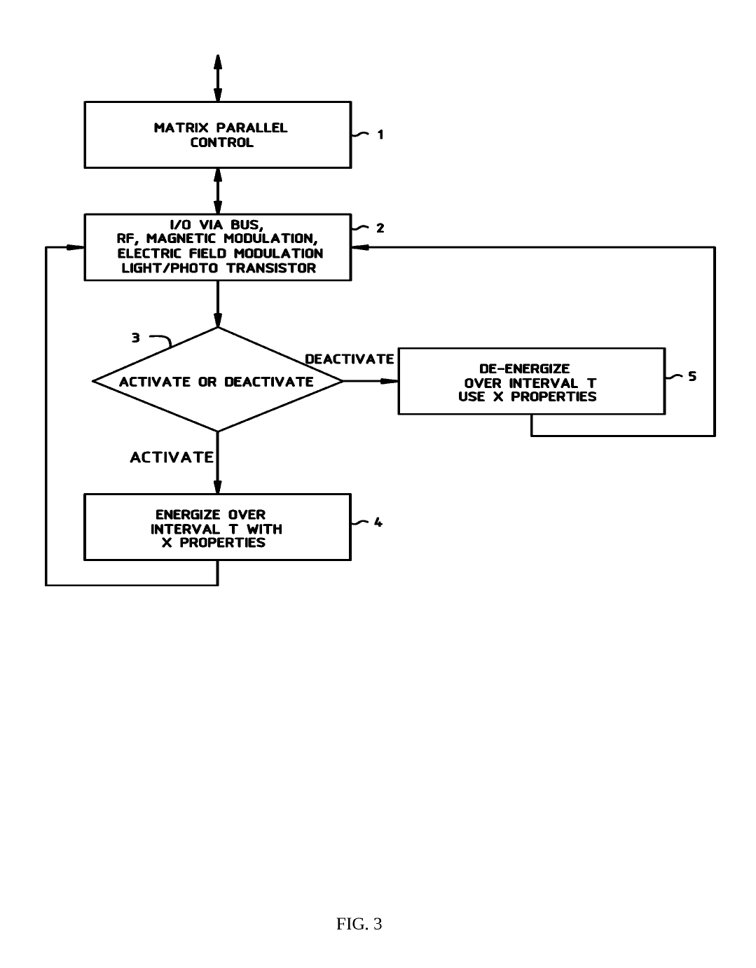

FIG. 3 illustrates a flow chart describing a procedure for parallel command or op code processing by an individual electric field processor emitter that is one of a plurality that populate a matrix, grid, or lattice and are commanded or issued op codes in parallel over or throughout the entire matrix, grid, or lattice of electric field processor emitters at the same time 1 via a bus, radio frequency, magnetic or electric field modulation or via visible or non-visible light 2. If the individual electric field processor emitter determines that it is at an x,y or x,y,z or polar or spherical coordinate affected by the op code sent to the electric field processor emitter then it processes the op code 3. The electric field is activated 4 or deactivated 5 with the given properties X. X may be characteristics of: steady negative value, steady positive value, negative limit voltage, positive limit voltage, zero cross, step voltage with number of steps and increments, step quantum time, voltage extrema positive, voltage extrema negative. Any necessary reply, feedback or a synchronization is sent back to the matrix.

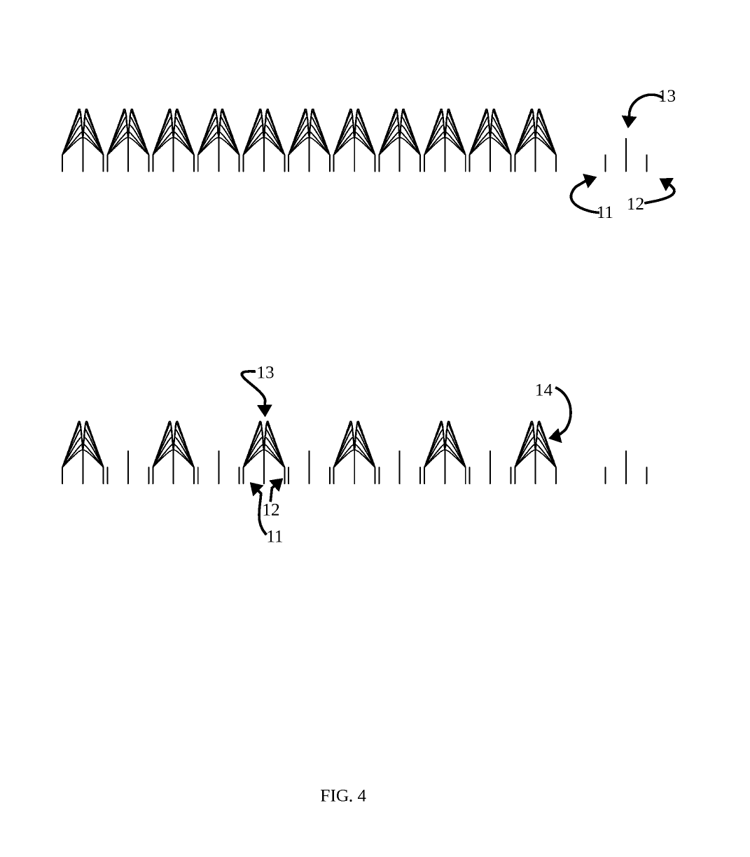

FIG. 4 details the conductor body combinations 11, 12 and 13 in a 1×12 bus like array arrangement to produce parallel data for input into a tablet computer or mobile phone touch screen where the upper illustration shows eleven bits concurrently producing eleven electric fields represented by the rough field lines 14 to indicate the binary number 11111111111 with an additional bit twelve for handshake, clock or bus timing and the lower part of the drawing shows another frame of twelve conductor combinations transmitting the binary number 10101010101 in parallel wherein these conductor or conductor traces in such a configuration are painted, deposited or silk screened onto a clear material or other to fit or snap on the lower portion or some portion of a tablet or mobile phone wherein the capacitors, transformers and other electronics can be housed in the same piggy back clip on device that carries the screen overlay with the conductors.

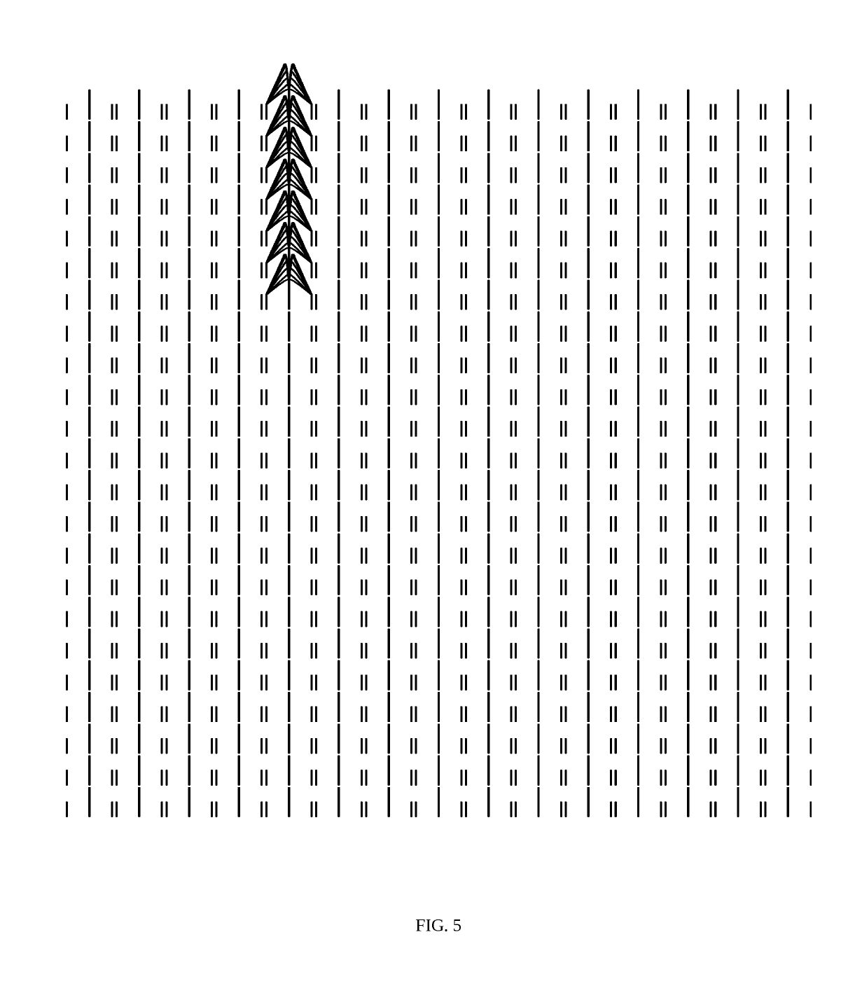

FIG. 5 details the field activation depicted by rough field lines of flux to approximate a vertical finger swipe on a 23×15 lattice for use with a tablet or mobile phone touch screen wherein each individual field is activated in a sequence.

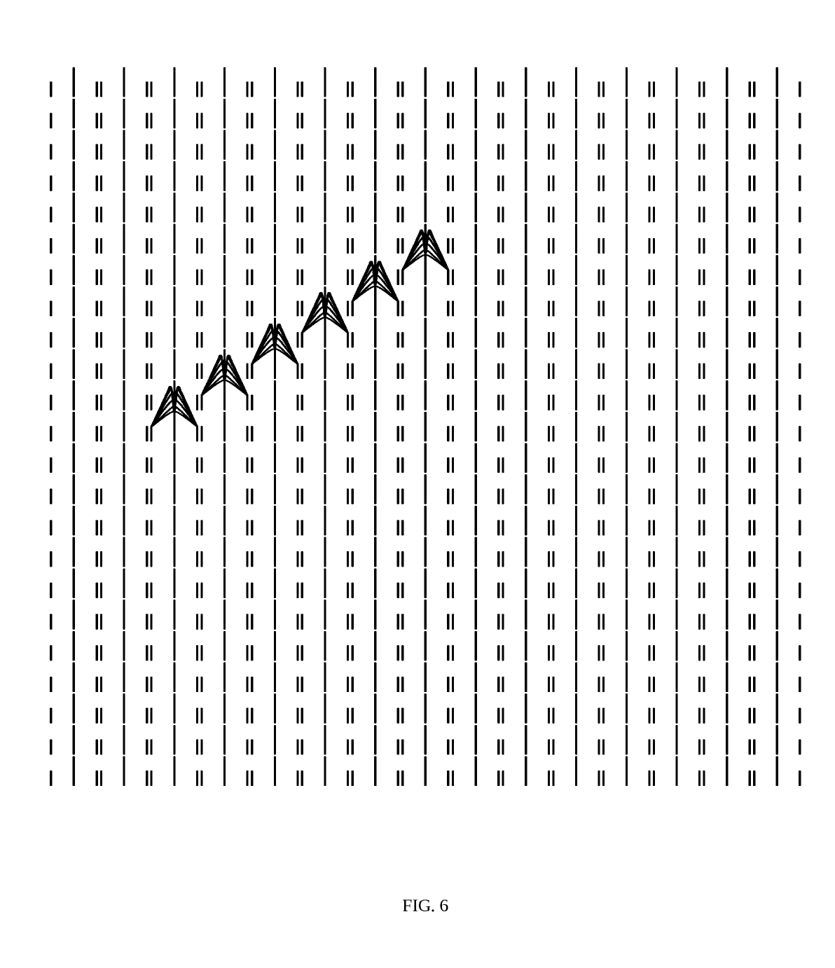

FIG. 6 details the field activation depicted by rough field lines of flux to approximate a diagonal finger swipe on a 23×15 lattice for use with a tablet or mobile phone touch screen wherein each individual field is activated in a sequence.

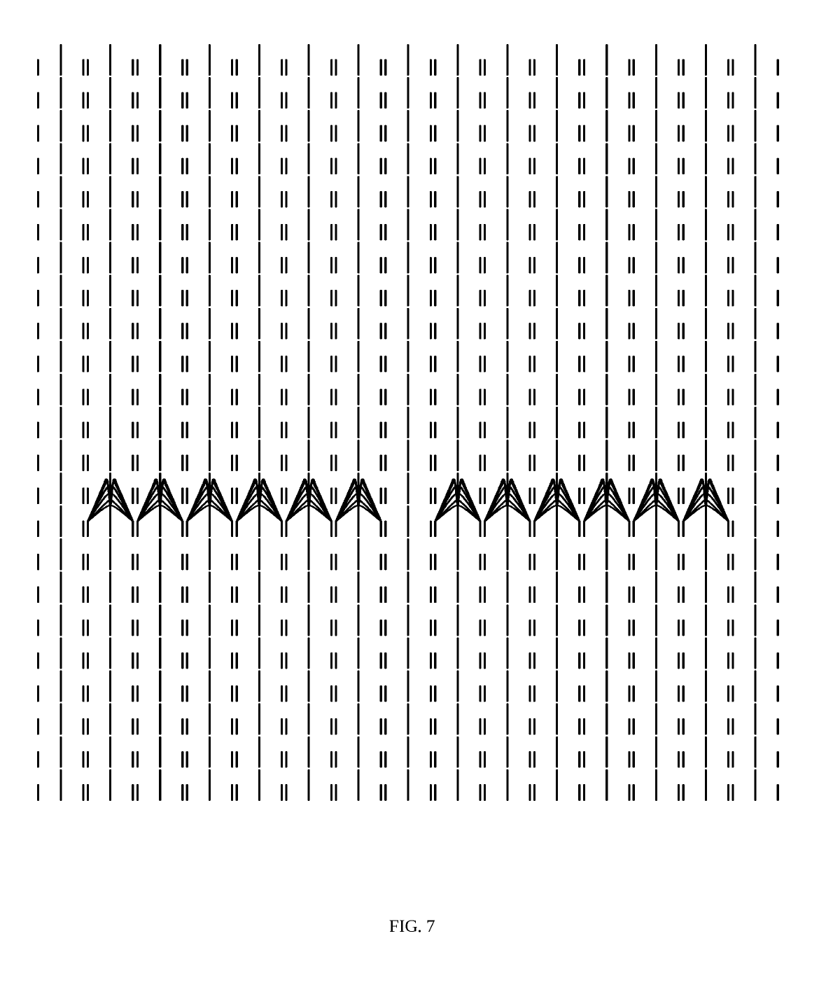

FIG. 7 details the field activations depicted by rough field lines of flux to approximate a finger pinch sequence on a 23×15 lattice for use with a tablet or mobile phone touch screen wherein two fields on each side are activated concurrently in a sequence

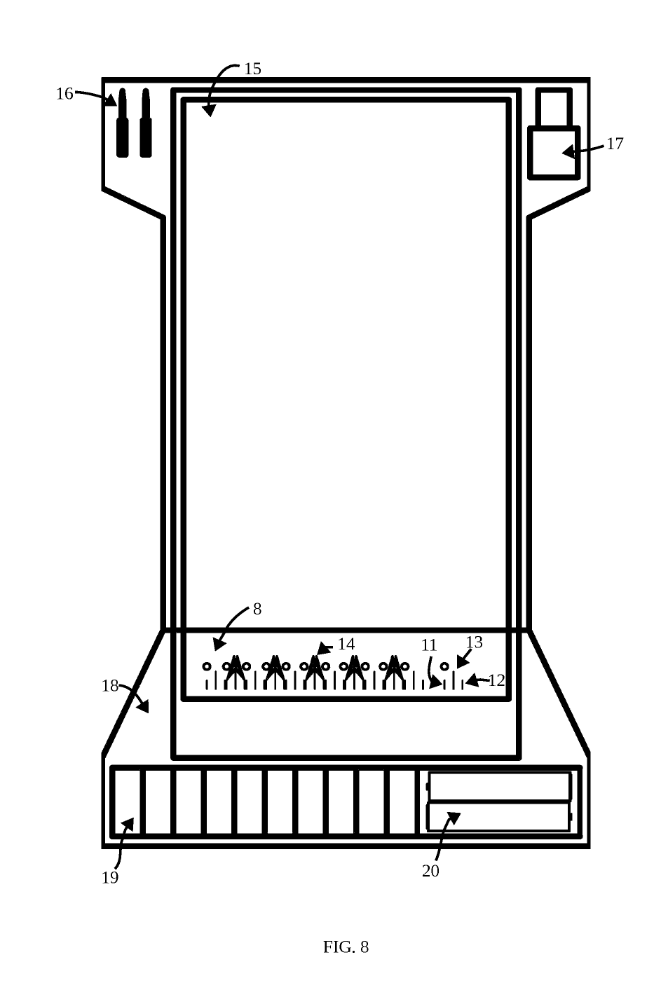

FIG. 8 details a form fitting snap on or slip on device/case 18 embodiment of this invention that fits securely over the lower portion of the mobile phone or tablet or the entire tablet or mobile device 15 wherein a conductor lattice of 12 electric field emitters produce 11 bits of parallel digital input into the tablet or mobile phone and an array of 12 photo transistors produce 11 bits of parallel output from the tablet or mobile phone. The 1×12 matrix of field emitting conductor body groupings 11, 12, and 13 each has an associated phototransistor 8. Control electronics 19 and batteries are contained inside the case 20 and activate the field emitters to produce electric fields and fringe fields 14 which are interpreted by the touchscreen as finger touches but utilized as parallel input data. The phototransistors provide output from the tablet computer or mobile phone while the field emitter 1×12 matrix provides input into the mobile phone or tablet computer. Wireless probes 17 or other wired probes 16 are stored in the case as well.

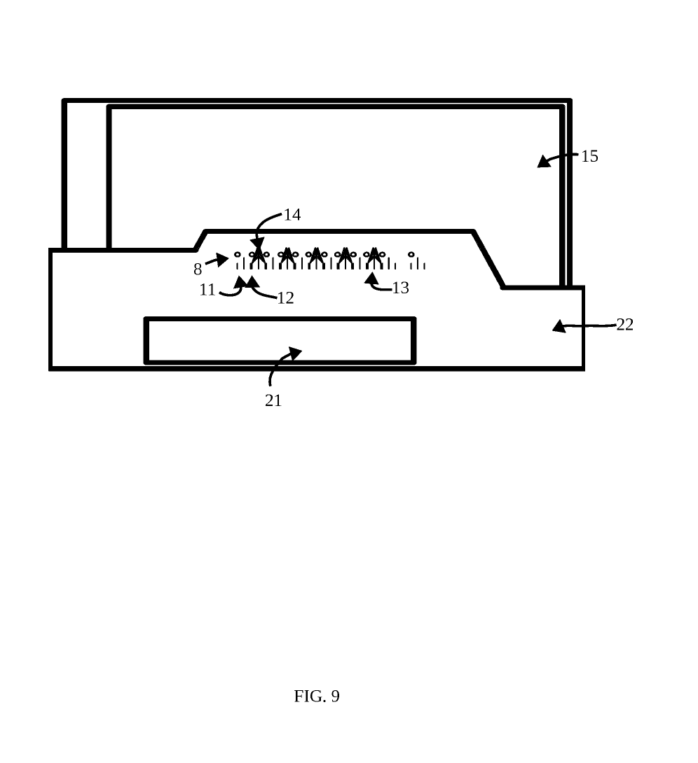

FIG. 9 details a snap in card slot like fixture or partial form fitting plastic case 22 to accept a mobile phone or tablet computer 15 like a blade including a 1×12 matrix of field emitting conductor body groupings 11, 12, and 13 embodied in this invention. Each grouping has an associated phototransistor 8. Control electronics are contained inside the card slot like fixture or partial case 21 and activate the field emitters to produce electric fields and fringe fields 14 which are interpreted by the touchscreen as finger touches but utilized as parallel data. The phototransistors provide output from the tablet computer or mobile phone while the field emitter 1×12 matrix provides input into the mobile phone or tablet computer. A grouping or array of these card slot like fixtures can be mounted in a parallel rack bus style arrangement to accept a large number of mobile phone or tablet computer “blades” to combine to form a scalable multiprocessing system.

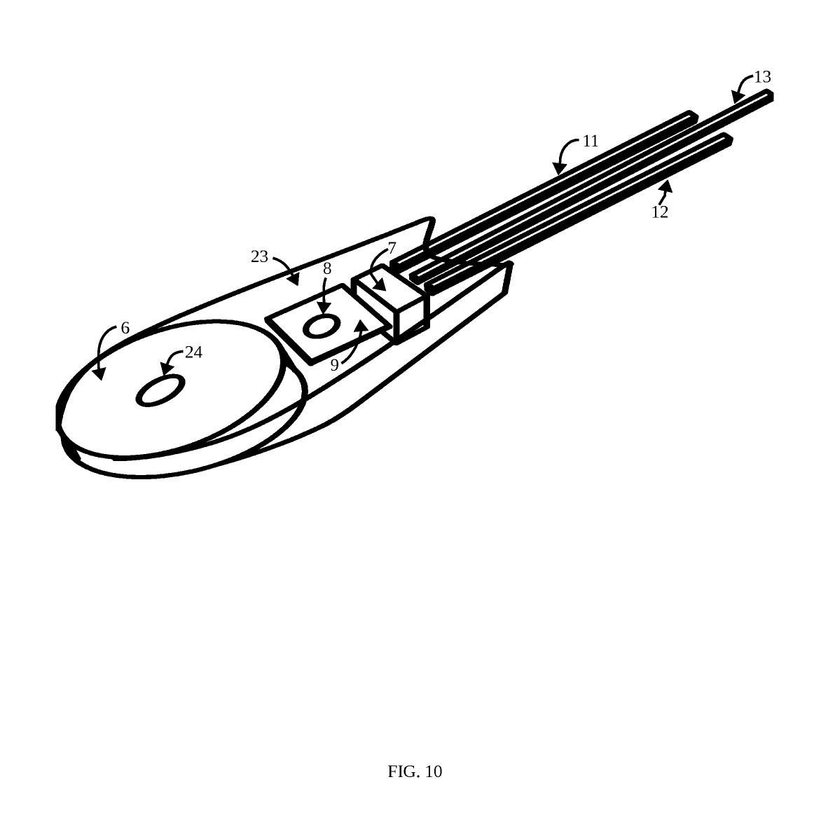

FIG. 10 details an Integrated Electric Field Processor Emitter housed in a streamlined enclosure or nacelle 23 which has a annulus or toroid appendage or hole 24 with the field emitter bodies protruding out the rear 11, 12, and 13. The annulus or toroid or hole allows the vehicle to be threaded like a bead on a wire as necessary hence the name Bead-like Energetic Autonomous Navigator combining a micro-transformer 6, capacitor 7, phototransistor 8, diodes, resistors and other circuitry 9 and a micro-processor.

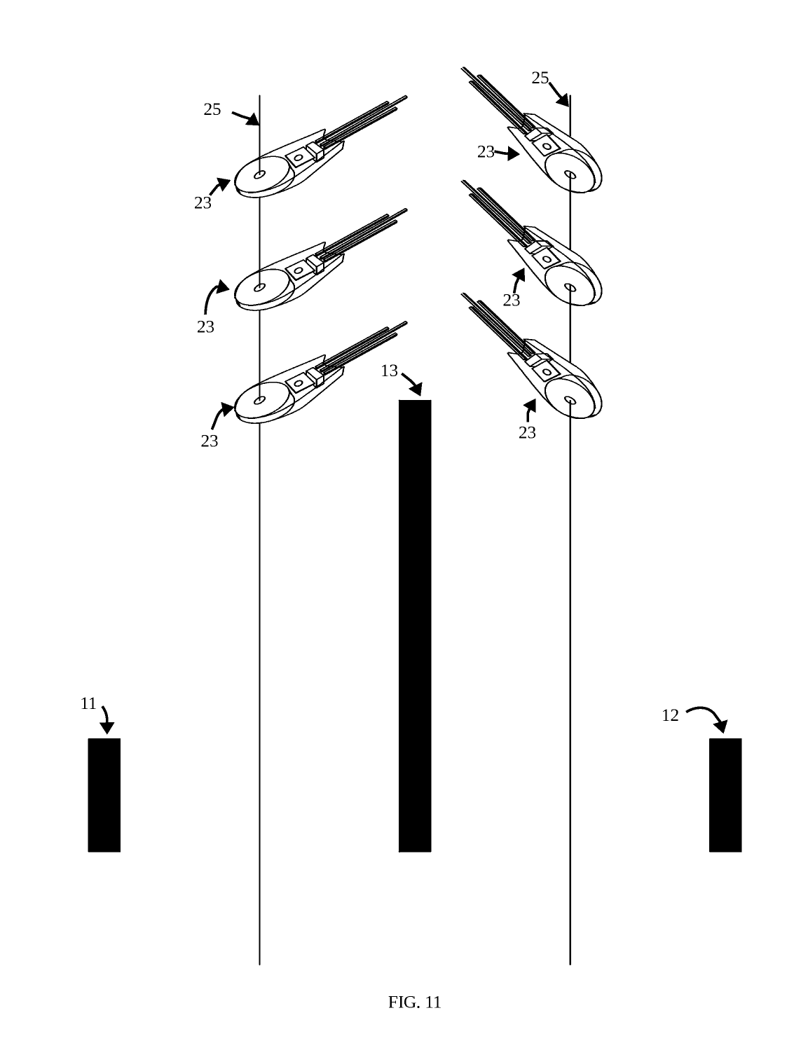

FIG. 11 details a wire which contains several cancelled B.E.A.D.s 23 aligned on a wire 25 over a field emitter conductor combination of two short conductor lengths 11 and 12 and a longer conductor length 13 of a larger emitter lattice wherein a bead can be moved down the wire. These B.E.A.N.S. can mob an area and increase field gradient force or do some other action en mass.

What is claimed is:

1. An electric field emitter and control device for use in plurality to populate a matrix, mesh, lattice, grid, or other arrangement over an area or in space wherein these devices create or emit and concurrently control pluralities of electric fields, and electric fringe fields wherein each emitter and control device consists of conductor endpoints, or terminations of positive and negative conductor lengths, or conductor body edges, or seams, intersections, vertices, joints, or asymmetric surfaces, or asymmetries used to generate and control pluralities of electric fields, electric fringe fields, or edge effects with control electronics and software that change charge configurations or properties to change the size, modulation, shape, wave properties of or in the electric field and the conductor endpoint or fringe field or end effects and effectively move or transform an electric field through or via a plurality of the conductor endpoint combinations with a plurality of lengths and shapes of conductors and conductor terminations, conductor body edges or seams, intersections, vertices, joints or asymmetric surfaces or asymmetries.

2. The electric field emitter and control device in claim 1 wherein a plurality of electric fields and fringe fields and end effects are used to render and move or change another independently generated electric field, change the field dynamics, field controlled trajectory, effective charge trajectory, or change the shape of another independently generated and controlled electric field.

3. The electric field emitter and control device in claims 1 and 2 wherein only conductor endpoints conductor body edges, intersections, seams or asymmetries or the area where a fringe field or end effect is created only occurs in the plane of a grid or corresponds with the point locations or faces of a lattice, matrix or mesh wherein all other parts of the conductor and device may be at an angle or offset from the conductor edge or endpoints that create the fringe field.

4. The electric field control and emitter device in claims 1, 2, and 3 wherein the conductor lengths, edges, or any fringe field generating asymmetric conductor body, terminations or conductor endpoints and the electronics, any micro transformers, capacitors, diodes, resistors and logic, or micro-code, or hard-wiring necessary for processing op codes, or to communicate to and from the device and generate and control the field are integrated or co-located or constructed between, among, within, near or local to each device wherein op codes or instructions are processed by the device.

5. The electric field control and emitter device in claim 4 wherein at least one instance of loop capable software executes in the device wherein op codes or instructions are processed at or integral with logic, microcode, or hard-wired circuitry co-located, near, between, among or inside the emitter device wherein the processor element of the device or resident software responds to commands or op codes, and input/output and or sensors to control the field emitter accordingly wherein each emitter device is a processor and is an Integrated Electric Field Processor Emitter.

6. The I.E.F.P.E. (Integrated Electric Field Processor Emitter) electric field control and emitter device in claim 5 wherein micro-machine or electromechanical machinery or structures necessary to move conductors, or conductor bodies, or do other mechanical, electrical, or chemical work, or to dock with other I.E.F.P.E. s or to move other structures to control the electric field, or structures necessary to store materials, store liquids, store waste for discard later or an in situ sensor that provides sensor input to the device or in situ output are integrated or inside the emitter device.

7. The electric field control and emitter devices described in claims 4, 5, and 6 wherein the device or combinations of multiple devices are packaged in integrated form such as a can, barrel, or rectangular prior-art surface mount, ball pin, DIN or other standard IC packaging.

8. The Integrated Electric Field Processor Emitters (I.E.F.P.E.) in claims 5 and 6 wherein a small on wire or rail/s or free floating or ranging bead-like or other shaped object contains a singularity or a plurality of Integrated Electric Field Processor Emitters on-board and can be powered by field energy or Rf wherein this bead like object of 900 microns or smaller and 900 microns and larger size can precisely position itself, propel, orient, maneuver itself or be energized, and guided by, through or around pluralities of fields created by an I.E.F.P.E. mesh or matrix wherein these bead-like objects can then be used singularly, en mass or in pluralities or pluralities of pluralities to probe, bore, clean, chemically bond, attach a chemical/material, conduct, emit an electric field, emit light, transmit telemetry, serve as a marker or perform other mechanical, electrical, or chemical or electromechanical actions wherein I.E.F.P.E. matrix or mesh commands and or on-board processing can control this Bead-like Energetic Autonomous Navigator (B.E.A.N.) robot.

9. The Bead-like Energetic Autonomous Navigator (B.E.A.N.) claim in 8 wherein a B.E.A.N. can scale up or add to itself and grow by joining/chaining or docking with other B.E.A.N.S. or by using given materials to change its own properties or remove waste materials or reload itself with chemical agent or material refilling or recharging reservoirs, batteries, or stocks of materials needed to do chemical, mechanical or electrical work wherein the B.E.A.N. may have to reposition itself to another location to acquire the material for recharging or offloading of waste material.

10. The Bead-like Energetic Autonomous Navigator in claims 8 and 9 wherein pluralities of Bead-like Energetic Autonomous Navigators maneuver themselves into positions on viruses or molecules or attempt to approximate a molecule or virus, or swarm to specific sites to plug a hole or perform work or approximate chemical combinations, mixtures, or formations of elements, or to catalyze a reaction.

11. The Bead-like Energetic Autonomous Navigator in claims 8, 9 and 10 wherein a B.E.A.N. can refresh or reconstruct itself after wear and tear or damage or create a different or evolved B.E.A.N. or create new B.E.A.N.s from material carried on board and other available resource material or have itself removed or repositioned by other beans or self destruct and then removed.

12. The claims in 8 and 9 wherein the Bead-like Energetic Autonomous Navigators are used as display image rendering devices, surfaces or objects for a mobile phone, computer, or tablet computer wherein the B.E.A.N.s are used as primary light emitting display elements or as reflective or prismatic elements of a display which can be built into the computing device, tablet computer, or mobile phone or an added display device using the touch screen display or display or portion of the touch screen or display with I.E.F.P.E.s or other to suspend, command, orient B.E.A.N.s or control light transmission to reflective or prismatic B.E.A.N.S to produce a 2D or 3D image.

13. The electric field control and emitter devices in claims 1, 2, 3, and 4 wherein the emitter devices are embedded, encapsulated or packaged in a clear or translucent material which can be placed on or near the surface of a tablet computer or mobile phone touch screen for use as input or I/O or simultaneous data transfer and can also approximate what a touchscreen interprets as a finger touch, simultaneous finger touches, finger swipe/s or pinch or other motion or multiple finger simultaneous touches or single finger touches or movements.

14. The electric field control and emitter devices in claims 1, 2, 3, 4, 5 and claim 6 wherein the emitters are placed in a position to overlay or mount in front of a tablet or mobile phone touch screen to be used as input or I/O for simultaneous data transfer and can approximate what the touchscreen interprets a finger swipe or pinch or other motion or multiple finger simultaneous touches or single finger touches or movements.

15. The electric field emitter control devices in claims 1, 2, 3, 4, 5, 6, 7, 8, 13, and 14 wherein phototransistors are included on an accompanying grid, matrix or lattice or integrated into the electric field emitter control device to provide an input light source facing in the opposite direction as the electric field generation side wherein the electric field of the electric field emitter may be directly activated by the phototransistor or not or the phototransistor may be oriented in any direction including having a second phototransistor facing the same direction as the electric field generation to provide a feedback or handshake.

16. The electric field emitter and control devices in claim 15 wherein a lattice/array or matrix of these devices are mounted to a clip on or snap on or form fitting device that clips over or fastens onto at least one side or fastens to at least the bottom or top of a tablet computer or mobile phone wherein a portion of the touch screen or the entire touch screen is overlaid with electric field processor emitters or the emitter conductors which may be encapsulated in a clear, translucent or an opaque material to allow input into the mobile phone or tablet computer.

17. The device in claim 16 wherein a phototransistor grid or array which may be of a different size or on a different mounting surface or in a different location is included with the electric field processor emitter or conductor emitter lattice to provide a means of output from the mobile phone or tablet computer or to provide feedback directly to the matrix or grid to indicate data transfer success or some other signal feedback.

18. The clip or snap on device in claims 16 and 17 wherein the clip or snap on devices are mounted such that several mobile phones or tablet computers may be mounted in a daisy chain, parallel bus or a set of slots allowing a plurality of tablet computers or mobile phones to be used as a scalable parallel multiprocessing system.

19. The electric field control and emitter devices in claims 13, 14, 15, 16, 17 and 18 wherein it is used as input and output to allow several mobile phones or tablet computers to be used as blades or processing modules in a parallel, or super computer.

20. The electric field control and emitter devices in claims 13, 14, 15, 16, 17 and 18 wherein tablet computers or mobile phones are placed such that each tablet computer or mobile phone touchscreen overlaps another tablet computer or mobile phone touchscreen in a cascade like or chain like stacking of tablet computers or mobile phones creating a multiprocessing system.

21. The electric field emitter in claims 13, 14, 15, 16, 17 and 18 wherein it is used as an input device to allow several tablet computers or mobile phones to pass quantum data to be used as processing units of a quantum computer.

22. The electric field emitter in claims 13, 14, 15, 16, and 17 used as the input method for use as a pay point or security card entry or secure transaction panel/kiosk where one can perform a secure financial transaction, or token free or ticket free entry and exit using a tablet or mobile phone, pass key or entry card key replacement or augmentation wherein the mobile phone or tablet computer is used or placed near the electric field input matrix allowing the tablet or mobile phone to pass a private password or response to a query to the phone.

23. The electric field emitter in claims 13, 14, 15, 16, and 17 wherein it is used to pass a key either considered public or private into the mobile phone or tablet computer and visa versa (to pass the a key either public or private from the mobile phone.

24. The field emitter and control devices in claims 1, 2, 3, 4, 5, 6, 7, 8, and 9 wherein pluralities of grid or matrix field control devices are used to perform computational field dynamics in real time to render, warp, move, propel, reshape, divide, multiply, control or change properties, or effect an electric field in space or pluralities of fields in space

25. The field emitter and control devices in claims 1, 2, 3, 4, 5, 6, 7, 8, and 9 wherein communication to and from individual Integrated Electric Field Processor Emitters or emitter and control devices is done via bus logic, discrete logic, radio frequency, visible light or non-visible light, electric field or electric field impulses or magnetic field or magnetic impulses.

26. The field emitter and control devices in claims 1, 2, 3, 4, 5, 6, 7, 8, and 9 wherein communication to and from Integrated Electric Field Processor Emitter matrices, meshes, lattices or other arrangements of a plurality of electric field emitter and control devices over an area or in space is done concurrently via bus logic, discrete logic, radio frequency, electric field or electric field impulses or magnetic field or magnetic impulses, or via visible light or non-visible light beamed over the matrix wherein the feedback response of all of the Integrated Electric Field Processor Emitters back to the matrix is a synchronization singularity or synchronization barrier.

27. Communication between tablet computers or mobile phones wherein light output from a tablet computer or mobile phone activates a phototransistor which in turn activates an electric field directly wherein the electric field triggers the input touch screen of the another tablet or mobile phone which also has the inverse to allow for two way communication wherein combinations of activations of an array of multiple phototransistors and in turn multiple touch screen senses occur simultaneously to transfer data in a parallel manner or bus cycle wherein input and output can occur in and out of each tablet computer or mobile phone independently, asynchronously or synchronously and wherein one light sourced output or set of light sourced outputs representing parallel bits or a single bit from an individual tablet or mobile phone can activate the electric field/s representing parallel bits or a single bit on a plurality of receiving tablet computers or mobile phones or broadcast to a plurality of an entire receiving set of tablet computers or mobile phones or a subset of only those addressed wherein a plurality of tablet computers or mobile phones can communicate creating a scalable parallel processing system.

28. The Electric Field Processor Emitter devices and matrix of claims 1, 2, 3, 4, 5, 6, 7 wherein the matrix in designed into the handheld tablet computer or mobile phone or mobile computing device or is packaged to attach to the tablet computer or mobile phone or computing device wherein the tablet or mobile phone becomes the matrix controller and as a unit can be placed near, on, attached or oriented to be used to read feedback or changes in the electric field matrix to measure, or sense or induce and produce a field to cause a reaction, or to control or orient objects such as the Bead-like Energetic Autonomous Navigators in claim 8.

29. The electric field emitter in claims 1, 2, 3, 4, 5, 6, 7, 8, 9, 10, 11, 12, 13, 14, 15, 16, and 17 wherein a charged, non-charged, dipole, non-dipole, object with integrated on-board computer controlled pole orientation or a plurality of such objects released in space affected by electric fields emitters and can be moved or manipulated or changed in orientation, location, configuration, trajectory, movement to do work, navigate, emit light, or to provide a physical or viewable figure, shape, reflective surface, combined reflective surfaces, holographic or multidimensional image.
